(19) United States
(12) Patent Application Publication
(10) Pub. No.: US 2015/0103077 A1
(43) Pub. Date: Apr. 16, 2015

(54) INTERSECTION AVOIDANCE IN MESH EDITING

(71) Applicant: SCHLUMBERGER TECHNOLOGY CORPORATION, Sugar Land, TX (US)

(72) Inventor: Bjarte Dysvik, Royneberg (NO)

(21) Appl. No.: 14/512,977

(22) Filed: Oct. 13, 2014

Related U.S. Application Data
(60) Provisional application No. 61/890,646, filed on Oct. 14, 2013.

(51) Int. Cl. G06T 17/20

(52) U.S. Cl. CPC G06T 17/205
USPC 345/420

(57) ABSTRACT

Systems, media, and methods for mesh editing are provided. For example, the method may include receiving a selection of a selected portion of a mesh, and receiving an instruction to move the selected portion of the mesh by a first distance in a direction. The method may also include defining an influence operator based on a location of the selected portion of the mesh, and determining that a second portion of the mesh is disposed within the influence operator. The method may further include moving the second portion of the mesh to avoid an intersection with the selected portion, and moving the selected portion of the mesh by the first distance and in the direction.

### CROSS-REFERENCE TO RELATED APPLICATIONS

This application claims priority to U.S. Provisional Patent Application No. 61/890,646, which was filed on Oct. 14, 2013 and is incorporated herein by reference in its entirety.

### BACKGROUND

In computer models, surfaces of the object may be represented by meshes. Meshes are formed by a series of vertices that are connected by edges to form elements, e.g., triangles, in a process known as “tessellation.”

In some contexts, it may be advantageous to edit the representation of the object, e.g., the mesh of the surface. For example, two portions of an object may be connected, despite initially being represented as disconnected in the model. In other cases, the two portions may be disconnected, despite being represented as connected in the model. In such cases, the meshes may be changed to account for the changed representation.

Such changes in the surface features of the object may result in mesh intersections. Mesh intersections may be problematic, however, because they may lead to inaccuracies in calculations based on the model. For example, such calculations may consider the volume of the object, or a certain part of the object. Where the mesh intersects, the volume of the intersection may be counted twice or not at all.

Various techniques have been implemented to avoid or remove such intersections. For example, rules are sometimes applied to ensure that the edited meshes do not intersect, thereby constraining the editing that can occur. In other cases, after the editing occurs, the boundaries of the meshes may be checked to find areas of overlap. If overlap is found, the mesh may revert to the previous state, and the system may re-attempt the editing process. However, in the case of large meshes with millions of elements (or more), such techniques may be computationally-intensive, and may result in lengthy runtimes in situations where real-time or near-real-time operation may be desired.

### SUMMARY

Embodiments of the present disclosure may provide systems, media, and methods for mesh editing. For example, the method may include receiving a selection of a selected portion of a mesh, and receiving an instruction to move the selected portion of the mesh by a first distance in a direction. The method may also include defining an influence operator based on a location of the selected portion of the mesh, and determining that a second portion of the mesh is disposed within the influence operator. The method may further include moving the second portion of the mesh to avoid an intersection with the selected portion, and moving the selected portion of the mesh by the first distance and in the direction.

It will be appreciated that the foregoing summary is intended merely to introduce certain aspects of the disclosure. These and other aspects are more fully described below. As such, this summary is not intended to be limiting on the claims.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a flowchart of a method for mesh editing, according to an embodiment.

FIGS. 2-4 illustrate conceptual views of a mesh being edited, according to an embodiment.

FIGS. 5-7 illustrate conceptual views of a three-dimensional object, with a surface mesh thereof being edited, according to an embodiment.

FIG. 8 illustrates a schematic view of a computing system, according to an embodiment.

### DETAILED DESCRIPTION

The following detailed description refers to the accompanying drawings. Wherever convenient, the same reference numbers are used in the drawings and the following description to refer to the same or similar parts. While several embodiments and features of the present disclosure are described herein, modifications, adaptations, and other implementations are possible, without departing from the spirit and scope of the present disclosure.

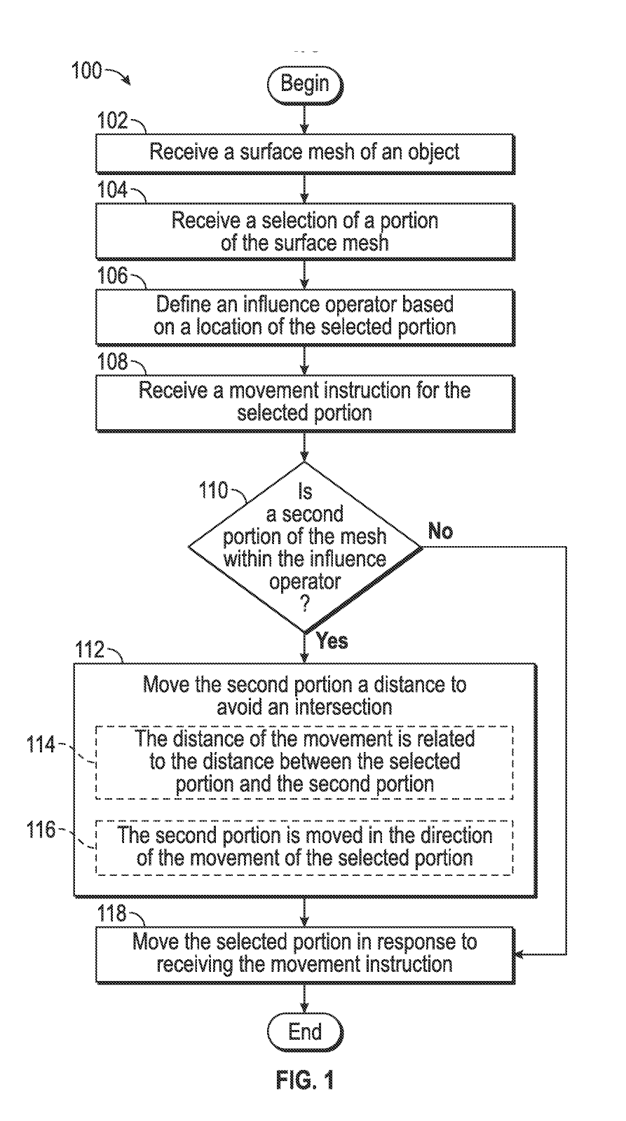

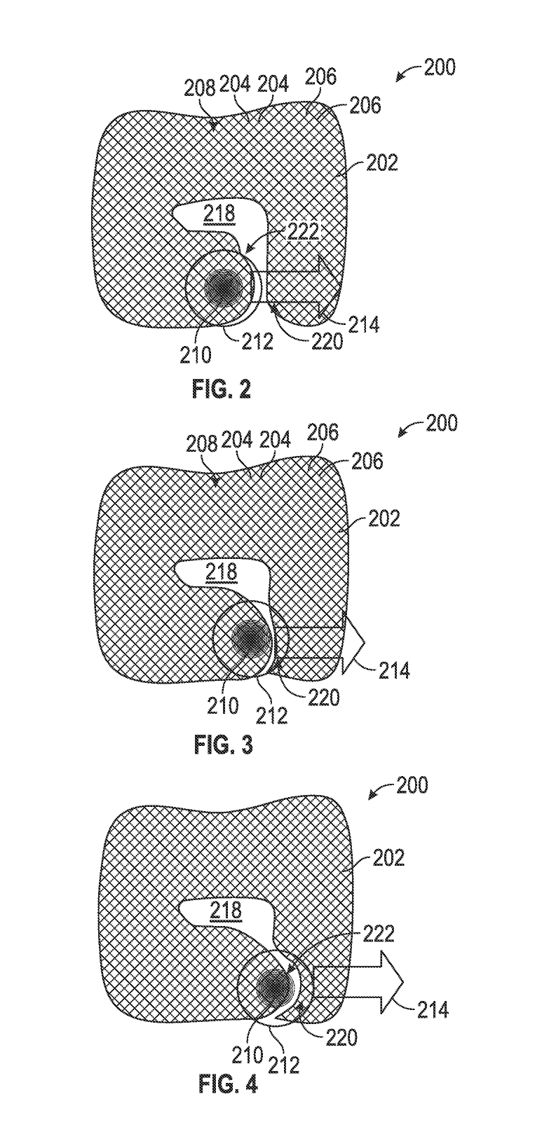

FIG. 1 illustrates a flowchart of a method 100 for editing a mesh, according to an embodiment. The mesh may be a digital representation of a two-dimensional, three-dimensional, or other multi-dimensional surface of an object, such as a seismic feature. In other embodiments, other types of features or objects may be employed (e.g., geological features or objects may be modeled), without limitation. To facilitate an understanding of the various aspects of the method 100, reference will also made, in turn, to the conceptual depictions of FIGS. 2-4, with continuing reference to FIG. 1.

As shown in FIG. 1, the method 100 may begin by receiving a surface mesh of an object, as at 102. FIGS. 2-4 depict a two-dimensional representation of such an object 200, defined, as shown, by the surface mesh 202. The mesh 202 may include vertices 204 connected together via edges 206, thereby defining mesh elements 208. The mesh 202 may be calculated as part of the method 100, or may be received from an external source, such as a mesh-editing process provided by a software application, for example. Moreover, the mesh 202 may be calculated in any suitable way, following any suitable rules, etc., without limitation. Additionally, the plurality of mesh elements 208 may be triangular, polygonal, or any other suitable shape.

In some cases, with the mesh 202 received at 102, the method 100 may also include displaying the object 200, e.g., on a monitor coupled with a processor, input peripherals, etc. of a computing system, as will be described in greater detail below. In other embodiments, the object 200 and/or the mesh 202 might not be displayed until another point in the method 100, or may not be displayed.

The method 100 may proceed to receiving a selection of a part (e.g., a “selected” portion 210) of the surface mesh 202, as at 104. The selection at 104 may be received via an input peripheral, e.g., as directed by a user. For example, a user may cause a cursor to hover over a portion of the mesh 202 and then click on the mesh 202 to select the portion 210. In another embodiment, the user may employ a keyboard or any other input device, to similar effect. Moreover, in other embodiments, the “selection” may be part of an algorithm, e.g., pushing, pulling, smoothing, refining, and decimation, etc., which may include causing the mesh 202 to be moved, as will be described in greater detail below. Additionally, the portion 210 selected at 104 may be one or more vertices 204, one or more edges 206, and/or one or more elements 208.

The method 100 may then proceed to defining an influence operator 212 based on a location of the selected portion 210, as at 106. The influence operator 112 may be defined in the same number of dimensions as the object in the object 200. Accordingly, the illustrated influence operator 212 is formed as a circle, and in a three-dimensional context, may be a sphere. The influence operator 212 may be centered at the selected portion 210. In other embodiments, the location of the influence operator 212 may be selected in other ways, based on the location of the selected portion 210. For example, the influence operator 212 may be non-spherical, but with a center of “mass” at the selected portion 210. In some embodiments, the influence operator 212 may have a variable density, such that the center of mass is not at the center of the volume of the influence operator 212. Further, the influence operator 212 need not be spherical or circular, but may be any suitable shape, including, without limitation, cylindrical, prismatic, conical, etc. As will be appreciated from the foregoing several options among many contemplated, a variety of schemes for determining the location of the influence operator 212 may be devised and employed consistent with the present disclosure.

Returning to FIG. 1, the method 100 may proceed to receiving a movement instruction for the selected portion 210, as at 108. The movement instruction may be input by a user. Continuing with the example from above with the user clicking the selected portion with a mouse, the user may hold the click and begin dragging the selected portion 210 of the mesh 202. In another embodiment, the movement instruction may be provided as part of an algorithm, such as a smoothing or other type of algorithm, which may include moving the mesh 202. The instruction to move the selected portion 210 may result in a surrounding portion of the mesh 202 being moved, so as to conform to the shape of the object to the movement.

FIGS. 2-4 illustrate a conceptual view of either such case, and/or others, in which the selected portion 210 is moved in the direction indicated by arrow 214. This moving instruction, when implemented (e.g., later in the method 100, below) may result in an area of the mesh 202 being changed, for example, enlarged, narrowed, and/or otherwise appearing differently from its previous shape (e.g., stretched). Moreover, the direction of arrow 214 may be toward a second portion 220 of the mesh 202. For example, the movement instruction may be to enclose an internal cavity 218 or another feature.

The movement instruction may be discretized or otherwise partitioned into increments of smaller movements. For example, with a user pulling the selected portion 210, e.g., by clicking and dragging, the movement instructed may be relatively large and/or received over a period of time; thus, the method 100 may consider the movement instruction over several increments, which may be location-based or time-based, or both. For example, the difference between the views of FIGS. 2 and 3 may represent a first increment of movement, while the difference between the views of FIGS. 3 and 4 may represent a second increment of movement. In other embodiments, the instruction may be considered in total (e.g., FIGS. 2-4 may be considered together).

The method 100 may continue with determining whether the second portion 220 of the mesh 202 is within the influence operator 212, as at 110. The second portion 220 may be part of the same mesh 202 (i.e., a part of the same object 200), but may be separated from the selected portion 210 by a gap 222 that the mesh 202 does not span. Accordingly, moving the selected portion 210 in the direction of the second portion 220 across the gap 222 may present a risk of intersection. It will be appreciated, however, that the second portion 220 may be part of another object or another mesh.

When (or if) the method 100 determines at 110 that the second portion 220 is located within the influence operator 212, the method 100 may proceed to moving the second portion 220 by a distance to avoid an intersection with the selected portion 210. In particular, the method 100 may include identifying vertices 204 of the mesh 202 that lie within the influence operator 212. The vertices 204 may be stored by location, and, with the shape and “center” of the influence operator 212 known, the identification of the vertices 204 located within the influence operator 212 may proceed using any suitable data structure and/or searching algorithm. Once identified, the vertices 204 may be moved. In some cases, such movement may result in a recalculation of the mesh 202 at least in the second portion 220, but in other cases, the vertices 204 and edges 206 may be preserved, and may not require recalculation of the mesh 202 to implement the movement.

As shown at 114, a distance of the movement of the second portion 220, e.g., the vertices 204 thereof, may be related to the distance between the vertices 204 and the selected portion 210, e.g., the center of the influence operator 212. In an example, the movement may be proportional to the distance between the selected portion 210 and the vertex 204 that is being moved. To provide such proportional movement, the influence operator 212 may define a gradient of influence. That is, proceeding outward from the selected portion 210 (e.g., the center of the influence operator 212), the distance that the vertex 204 of the second portion 220 is moved may increase. At the outer extents of the influence operator 212, such movement may be a relatively small fraction of the distance that the selected portion 210 is moved. However, if the vertex 204 is near to the selected portion 210 (e.g., intersection is imminent), the movement of the vertex 204 may be nearly the same as the movement of the selected portion 210. Moreover, to avoid the collision, the vertices 204 (and edges 206) being moved may be moved in the same direction as the selected portion 210 is being moved.

FIGS. 2-4 illustrate three such movements, as at 112, according to an embodiment. As shown in FIG. 2, the second portion 220 is not within the influence operator 212. Accordingly, at 110, the method 100 may include determining that a move of the selected portion 210 to the right is allowable because the influence operator 212 does not overlap any other portions of the mesh 202. In FIG. 3, however, the edge of the second portion 220 is within the outer extent of the influence operator 212, which may be determined at 110. Accordingly, the method 100 may proceed to moving the second portion 220 by a distance proportional (or otherwise related to) the movement of the selected portion 210 and in the same direction, for example.

The gradient of influence of the influence operator 212 may be defined in any suitable manner. For example, the gradient may be related to a ratio of the distance between the vertex 204 to be moved and the selected portion 210 and a distance between the center and the outer extent of the influence operator 212 (e.g., the radius of the influence operator 212). The ratio may be multiplied by the distance the selected portion 210 is moved, yielding the distance to move the second portion 220. In some cases, this calculation may result in different distances resulting in different proportional movements, e.g., according to the size of the influence operator 212 in a given direction (e.g., in a non-spherical context). In FIG. 4, the second portion 220 is near the center of the influence operator 212, and thus may be moved nearly, or the same, distance as is the selected portion 210, thereby maintaining the gap 222 and preventing an intersection between the selected portion 210 and the second portion 220. It will be appreciated that the gap 222 may be “maintained,” but may change size, e.g., shrink or stretch, as the mesh 202 is edited. The term “maintain” is generally used herein to refer to the gap 222 existing before and after the modification of the mesh 202. In some cases though, the gap 222 may be maintained and have the same size before and after the mesh-editing process. Further, moving the selected portion 210 may occur before, after, or while moving the second portion 220, without limitation.

When, as in FIG. 2, the method 100 includes determining that the influence operator 212 does not intersect another portion of the mesh 202 and/or after moving the second portion 220 (as in FIGS. 3 and 4), the method 100 may proceed to moving the selected portion 210 of the mesh 202 in response to receiving the instruction, as at 118. The method 100 may then end, if no further instructions (or increments thereof) are pending, or may loop back to determining if the influence operator 212 overlaps a second portion of the mesh 202, again at 110.

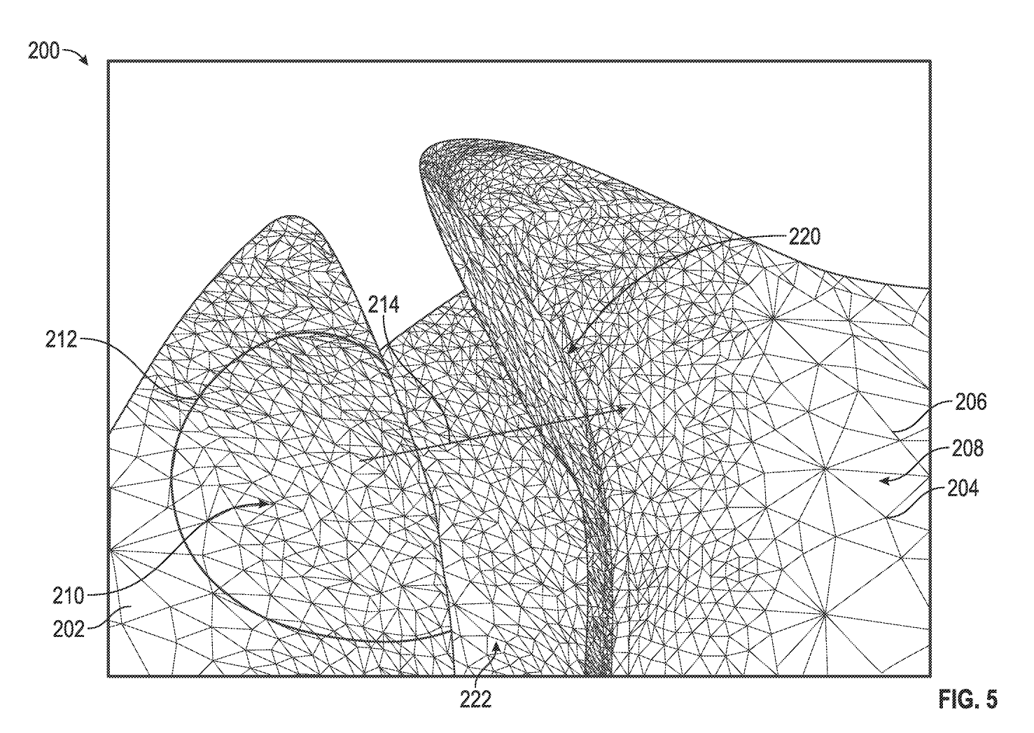

FIGS. 5-7 illustrate another example of an implementation of the method 100, in a three-dimensional view, according to an embodiment. As shown, in FIG. 5, the influence operator 212 may be defined based on the location of the selected portion 210, e.g., with the selected portion 210 at the center of the influence operator 212. The spherical influence operator 212 (in this embodiment) extends around the selected portion 210 and intersects the mesh 202 as indicated. As can be seen, the influence operator 212 does not overlap the second portion 220 in this case. As such, at least initially, movement of the selected portion 210 of the mesh 202 in the direction of the arrow 214 is tolerated and does not require intersection avoidance.

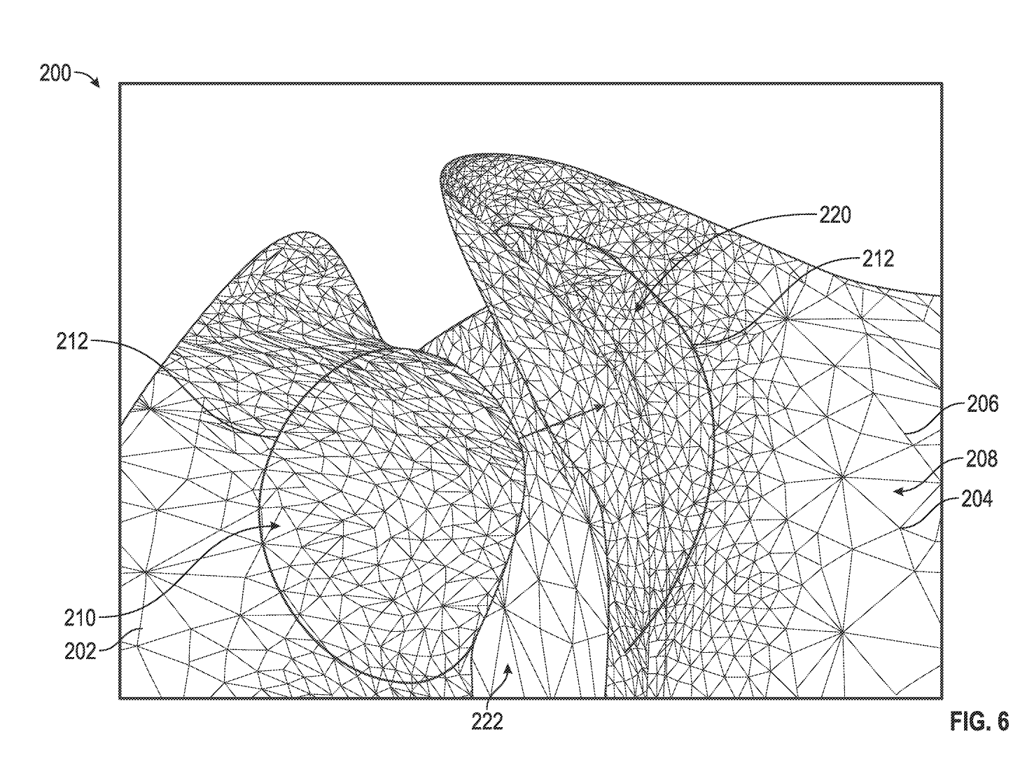

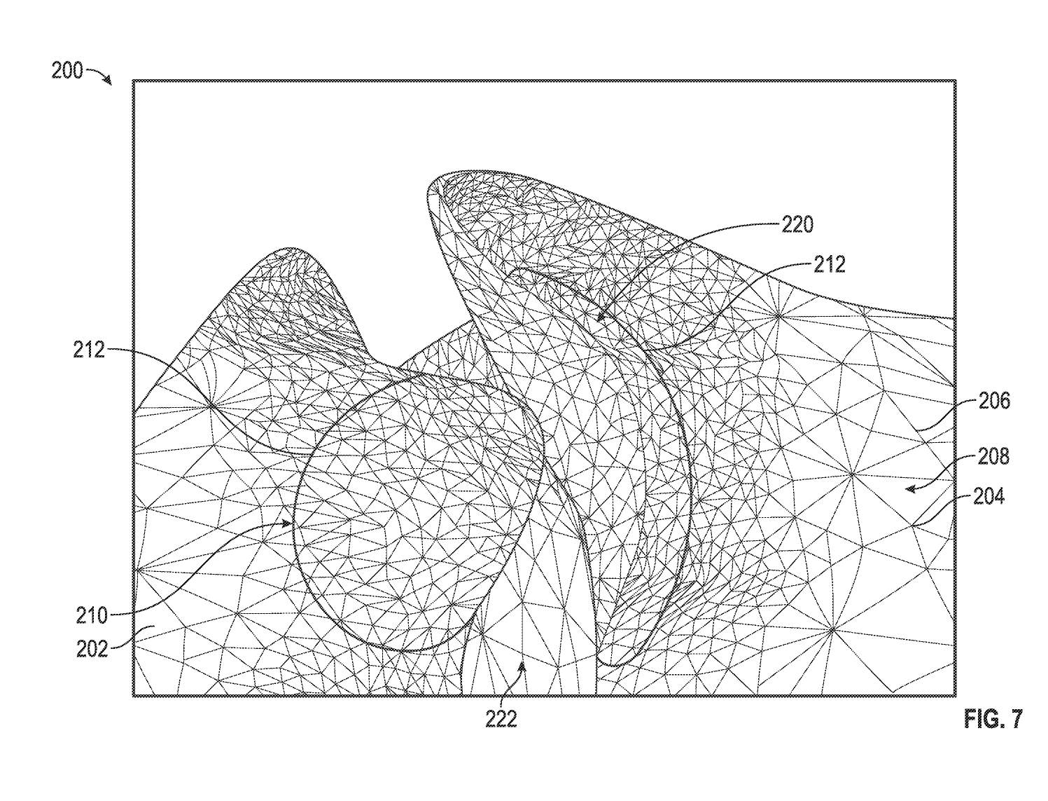

However, in FIG. 6, movement (which may be initiated by a subsequent move instruction or a subsequent increment of movement for the same instruction), may result in intersection avoidance because the second portion 220 is within the influence operator 212. Accordingly, to maintain the gap 222 and avoid intersection between the selected portion 210 and the second portion 220, the second portion 220 may be moved in the direction of the arrow 214, and the first portion 210 may also be moved. FIG. 7 may illustrate the result of the movement of the selected portion 210 and the second portion 220. As can be appreciated, the second portion 220 has been moved in the direction of the arrow 214 (to the right) to maintain the gap 222 as the selected portion 210 is moved. Since the second portion 220 was relatively near the extent of the influence operator 212 (i.e., a ratio of the distance between the selected portion 210 and the second portion 220 and the dimension (radius) of the influence operator 212 is relatively near to one), the movement of the second portion 220 may be small, relative to the distance that the selected portion 210 is moved. However, as can also be appreciated, the second portion 220, after both the selected portion 210 and the second portion 220 are moved, may not end up outside of the influence operator 212.

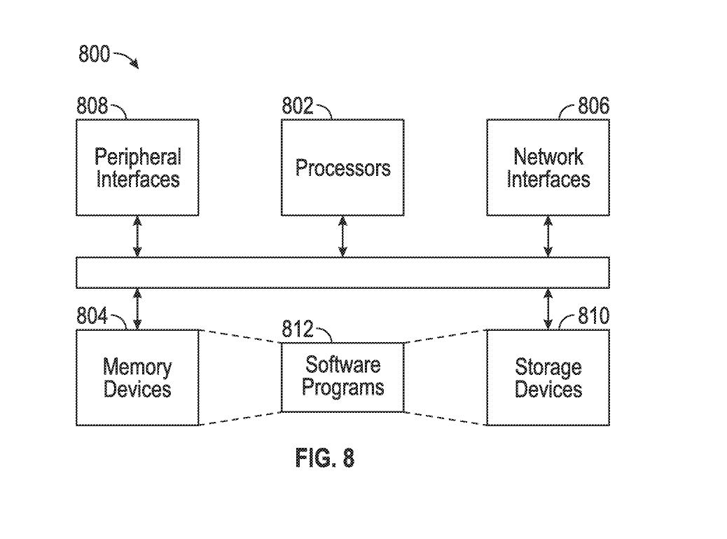

Embodiments of the disclosure may also include one or more systems for implementing one or more embodiments of the method of the present disclosure. FIG. 8 illustrates a schematic view of such a computing or processor system 800, according to an embodiment. The processor system 800 may include one or more processors 802 of varying core (including multiple-core) configurations and clock frequencies. The one or more processors 802 may be operable to execute instructions, apply logic, etc. It will be appreciated that these functions may be provided by multiple processors or multiple cores on a single chip operating in parallel and/or communicably linked together.

The processor system 800 may also include a memory system, which may be or include one or more memory devices and/or computer-readable media 804 of varying physical dimensions, accessibility, storage capacities, etc. such as flash drives, hard drives, disks, random access memory, etc., for storing data, such as images, files, and program instructions for execution by the processor 802. In an embodiment, the computer-readable media 804 may store instructions that, when executed by the processor 802, are configured to cause the processor system 800 to perform operations. For example, execution of such instructions may cause the processor system 800 to implement one or more portions and/or embodiments of the method 100 described above.

The processor system 800 may also include one or more network interfaces 806. The network interfaces 806 may include any hardware, applications, and/or other software. Accordingly, the network interfaces 806 may include Ethernet adapters, wireless transceivers, PCI interfaces, and/or serial network components, for communicating over wired or wireless media using protocols, such as Ethernet, wireless Ethernet, etc.

The processor system 800 may further include one or more peripheral interfaces 808, for communication with a display screen, projector, keyboards, mice, touchpads, sensors, other types of input and/or output peripherals, and/or the like. In some implementations, the components of processor system 800 need not be enclosed within a single enclosure or even located in close proximity to one another, but in other implementations, the components and/or others may be provided in a single enclosure.

The memory device 804 may be physically or logically arranged or configured to store data on one or more storage devices 810. The storage device 810 may include one or more file systems or databases in any suitable format. The storage device 810 may also include one or more software programs 812, which may contain interpretable or executable instructions for performing one or more of the disclosed processes. When requested by the processor 802, one or more of the software programs 812, or a portion thereof, may be loaded from the storage devices 810 to the memory devices 804 for execution by the processor 802.

Those skilled in the art will appreciate that the above-described componentry is merely one example of a hardware configuration, as the processor system 800 may include any type of hardware components, including any necessary accompanying firmware or software, for performing the disclosed implementations. The processor system 800 may also be implemented in part or in whole by electronic circuit components or processors, such as application-specific integrated circuits (ASICs) or field-programmable gate arrays (FPGAs).

The foregoing description of the present disclosure, along with its associated embodiments and examples, has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the disclosed embodiments.

For example, the same techniques described herein with reference to the processor system 800 may be used to execute programs according to instructions received from another program or from another processor system altogether. Similarly, commands may be received, executed, and their output returned entirely within the processing and/or memory of the processor system 800. Accordingly, neither a visual interface command terminal nor any terminal at all is strictly necessary for performing the described embodiments.

Likewise, the steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents. Further, in the above description and in the below claims, unless specified otherwise, the term “execute” and its variants are to be interpreted as pertaining to any operation of program code or instructions on a device, whether compiled, interpreted, or run using other techniques.

What is claimed is:

1. A method for mesh editing, comprising:
receiving a selection of a selected portion of a mesh;
receiving an instruction to move the selected portion of the mesh by a first distance in a direction;
defining an influence operator based on a location of the selected portion of the mesh;
determining that a second portion of the mesh is disposed within the influence operator;
moving the second portion of the mesh to avoid an intersection with the selected portion; and
moving the selected portion of the mesh by the first distance and in the direction.

2. The method of claim 1, wherein moving the second portion of the mesh comprises moving the second portion by a second distance that is related to the first distance.

3. The method of claim 2, further comprising:
determining a third distance between the second portion of the mesh and the selected portion of the mesh; and
determining the second distance based on the third distance, a dimension of the influence operator, and the first distance.

4. The method of claim 3, wherein determining the third distance comprises determining the third distance for one or more vertices of the second portion of the mesh.

5. The method of claim 3, wherein determining the second distance comprises determining a ratio of the third distance to the dimension and multiplying the ratio by the first distance.

6. The method of claim 3, wherein the influence operator is a sphere, and the dimension is a radius of the sphere.

7. The method of claim 1, wherein the selected portion of the mesh comprises one or more vertices of the mesh.

8. The method of claim 1, further comprising maintaining a gap defined between the selected portion and the second portion when moving the selected portion, the second portion, or both.

9. The method of claim 1, wherein moving the second portion of the mesh comprises moving the second portion of the mesh in the direction.

10. A non-transitory computer-readable medium storing instructions that, when executed by a processor, cause the processor to perform operations, the operations comprising:
receiving a selection of a selected portion of a mesh;
receiving an instruction to move the selected portion of the mesh by a first distance in a direction;
defining an influence operator based on a location of the selected portion of the mesh;
determining that a second portion of the mesh is disposed within the influence operator;
moving the second portion of the mesh to avoid an intersection with the selected portion; and
moving the selected portion of the mesh by the first distance and in the direction.

11. The medium of claim 10, wherein moving the second portion of the mesh comprises moving the second portion by a second distance that is related to the first distance.

12. The medium of claim 11, wherein the operations further comprise:
determining a third distance between the second portion of the mesh and the selected portion of the mesh; and
determining the second distance based on the third distance, a dimension of the influence operator, and the first distance.

13. The medium of claim 12, wherein determining the second distance comprises determining a ratio of the third distance to the dimension and multiplying the ratio by the first distance.

14. The medium of claim 12, wherein the influence operator is a sphere, and the dimension is a radius of the sphere.

15. The medium of claim 10, wherein the selected portion of the mesh comprises one or more vertices of the mesh.

16. The medium of claim 10, wherein moving the second portion of the mesh comprises moving the second portion of the mesh in the direction.

17. A computing system, comprising:
one or more processors; and
a memory system comprising one or more computer-readable media storing instructions that, when executed by at least one of the one or more processors, cause the computing system to perform operations, the operations comprising:
receiving a selection of a selected portion of a mesh;
receiving an instruction to move the selected portion of the mesh by a first distance in a direction;
defining an influence operator based on a location of the selected portion of the mesh;
determining that a second portion of the mesh is disposed within the influence operator;
moving the second portion of the mesh to avoid an intersection with the selected portion; and
moving the selected portion of the mesh by the first distance and in the direction.

18. The system of claim 17, wherein moving the second portion of the mesh comprises moving the second portion by a second distance that is related to the first distance.

19. The system of claim 11, wherein the operations further comprise:
determining a third distance between the second portion of the mesh and the selected portion of the mesh; and
determining the second distance based on the third distance, a dimension of the influence operator, and the first distance.

20. The system of claim 19, wherein determining the second distance comprises determining a ratio of the third distance to the dimension and multiplying the ratio by the first distance.
